(19) United States
(12) Patent Application Publication
(10) Pub. No.: US 2026/0046084 A1
(43) Pub. Date: Feb. 12, 2026

(54) METHOD AND APPARATUS FOR CARRIER PHASE-BASED REFERENCE SIGNAL

(71) Applicant: LENOVO (SINGAPORE) PTE. LTD., Singapore (SG)

(72) Inventors: Abir BEN HADJ FREDJ, Frankfurt (DE); Alexander Johann Maria Golitschek Edler Von Elbwart, Darmstadt (DE); Robin Rajan THOMAS, Nauheim (DE); Karthikeyan GANESAN, Nauheim (DE)

(21) Appl. No.: 19/102,266

(22) PCT Filed: Aug. 10, 2023
(86) PCT No.: PCT/IB2023/058076

§ 371 Date: Feb. 7, 2025

Related U.S. Application Data
(60) Provisional application No. 63/396,897, filed on Aug. 10, 2022.

(51) Int. Cl. H04L 5/00; H04L 27/26; H04W 24/10

(52) U.S. Cl. CPC H04L 5/0048; H04L 27/2613; H04W 24/10

(57) ABSTRACT

Various aspects of the present disclosure relate to a user equipment (UE) and a transmission reception point (TRP) for wireless communication configured to generate a continuous positioning reference signal for continuous tracking of phase for positioning using a raised cosine technique, and transmit the continuous positioning reference signal, the continuous positioning reference signal extending across at least two contiguous symbols within a first subcarrier. The continuous positioning reference signal may be used to perform a phase measurement which is used to estimate a position of the UE.

### TECHNICAL FIELD

The present disclosure relates to wireless communications, and more specifically to a method and apparatus for a positioning reference signal.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

It is important for wireless networks to be able to provide accurate position measurements for UEs in the network. Improved positioning can enhance existing applications, and create opportunities for new applications that rely on highly accurate position data. While wireless networks have been capable of estimating position for some time, the accuracy of the position estimates still have considerable room for improvement.

### SUMMARY

The present disclosure relates to methods, apparatuses, and systems that support a positioning reference signal for phase-based positioning in wireless telecommunications.

Some implementations of the method and apparatuses described herein may further include generating a continuous positioning reference signal for continuous tracking of phase for positioning using a raised cosine technique; and transmitting the continuous positioning reference signal, the continuous positioning reference signal extending across at least two contiguous symbols within a first subcarrier.

In some implementations of the method and apparatuses described herein, generating the continuous positioning reference signal includes combining a transformed suffix of a first symbol with a transformed prefix of a second symbol that is contiguous with the first symbol.

In some implementations of the method and apparatuses described herein, the transformed suffix is generated by applying a first raised cosine to an initial suffix of a first symbol, and the transformed prefix is generated by applying a second raised cosine to an initial prefix of a second symbol.

In some implementations of the method and apparatuses described herein, applying the first raised cosine to the initial suffix includes modifying the initial suffix by a cosine that starts at 1 and rolls off to 0.

In some implementations of the method and apparatuses described herein, applying the second raised cosine to the initial prefix includes modifying the initial prefix by a cosine that starts at 0 and rolls on to 1.

In some implementations of the method and apparatuses described herein, the transformed suffix has 16 samples and the transformed prefix has 16 samples.

In some implementations of the method and apparatuses described herein, a cosine of the first raised cosine applied to the initial suffix is an inverse of the second raised cosine applied to the initial prefix.

In some implementations of the method and apparatuses described herein, the combined suffix and prefix is used as a prefix for a symbol in the continuous positioning reference signal.

In some implementations of the method and apparatuses described herein, positioning measurement report including a phase measurement of the continuous positioning reference signal is received by a UE.

In some implementations of the method and apparatuses described herein, the positioning measurement report including the phase measurement of the continuous positioning reference signal is provided by the UE to a network function.

In some implementations of the method and apparatuses described herein, a user equipment (UE) for wireless communication includes at least one memory, a transceiver, and at least one processor coupled with the at least one memory and configured to cause the UE to generate a continuous positioning reference signal for continuous tracking of phase for positioning using a raised cosine technique, and transmit the continuous positioning reference signal, the continuous positioning reference signal extending across at least two contiguous symbols within a first subcarrier.

In some implementations of the method and apparatuses described herein, a processor for wireless communication includes at least one memory; and a controller coupled with the at least one memory and configured to cause the controller to generate a continuous positioning reference signal for continuous tracking of phase for positioning using a raised cosine technique, and transmit the continuous positioning reference signal, the continuous positioning reference signal extending across at least two contiguous symbols within a first subcarrier.

In some implementations of the method and apparatuses described herein, a transmission reception point (TRP) includes a processor and a transceiver coupled to the processor, wherein the processor is configured to cause the TRP to generate a continuous positioning reference signal for continuous tracking of phase for positioning using a raised cosine technique, and transmit the continuous positioning reference signal, the continuous positioning reference signal extending across at least two contiguous symbols within a first subcarrier.

### BRIEF DESCRIPTION OF THE DRAWINGS

FIG. 1 illustrates an example of a wireless communications system that supports a positioning reference signal in accordance with aspects of the present disclosure.

FIG. 2 illustrates an example of a system that supports positioning reference signals in accordance with aspects of the present disclosure.

FIG. 3 illustrates an example of a block diagram of a device that supports positioning reference signals in accordance with aspects of the present disclosure.

FIGS. 4 and 5 illustrate flowcharts of methods that support positioning reference signals in accordance with aspects of the present disclosure.

FIG. 6 illustrates an example of a cyclic prefix-orthogonal frequency division multiplexing (CP-OFDM) waveform.

FIG. 7 illustrates an example of assembling a C-PRS using windowing raised cosine techniques.

FIGS. 8 and 9 illustrate examples of allocating resources to resource blocks.

FIG. 10 illustrates an example of a block diagram of a processor that supports positioning reference signals in accordance with aspects of the present disclosure.

### DETAILED DESCRIPTION

Current timing-based and angle-based RAT-dependent positioning methods benefit from the current NR positioning reference signal including positioning reference signal/sounding reference signal (PRS/SRS) design. Conventional DL PRS/UL SRS resource element (RE) pattern design follows a comb-structure design with a number of supported different densities, e.g. comb-2, comb-4, comb-6 and comb-12. This structure allows for improved estimation properties for the reference signal for timing measurements like RSTD, RTD, etc. However, the accuracy of these techniques is limited. Conventional carrier-based techniques tend to be relatively inaccurate, especially in comparison to satellite-based techniques, and are not capable of centimeter-level accuracy.

While certain satellite-based techniques are capable of centimeter-level accuracy, satellite signaling is very different from signaling in telecommunications networks. While satellite systems such as GPS and GLONASS broadcast signals from many different locations, cellular networks, especially 4G and 5G networks, use OFDM and other coding techniques to communicate in uplink and downlink.

Phase-based techniques can improve positional accuracy. There is currently a lack of support for RAT-dependent carrier phase-based positioning procedures in the 3GPP specifications.

Due to the nature of carrier phase positioning, the existing staggered positioning reference signal (PRS) pattern is inefficient for performing continuous phase tracking because the subcarrier frequency changes symbol by symbol. Additionally, the CP-OFDM waveform presents discontinuities due to the cyclic prefix, which produces a discontinuous PRS waveform, thereby reducing the reliability of carrier phase estimation.

Consequently, to achieve centimeter or millimeter-level accuracies using RAT-dependent carrier phase measurements-based positioning, a new reference signal design is needed. This disclosure presents a new positioning reference signal (C-PRS) design for carrier phase positioning that allows improved phase estimation performance. Characteristics of embodiments of the new reference signal are a contiguous time-domain RE mapping and a continuous OFDM waveform.

Phase-based positioning using conventional technologies in cellular networks is not capable of centimeter or millimeter level positioning. Discontinuities between symbols and conventional symbol mapping prevent centimeter or millimeter level positioning from being possible using conventional techniques.

Embodiments of the present application reduce or eliminate discontinuities between symbols and provide contiguous mapping, among other features, which facilitates carrier phase-based positioning with improved accuracy.

Aspects of the present disclosure are described in the context of a wireless communications system. Aspects of the present disclosure are further illustrated and described with reference to device diagrams, flowcharts that relate to positioning reference signals for phase-based positioning.

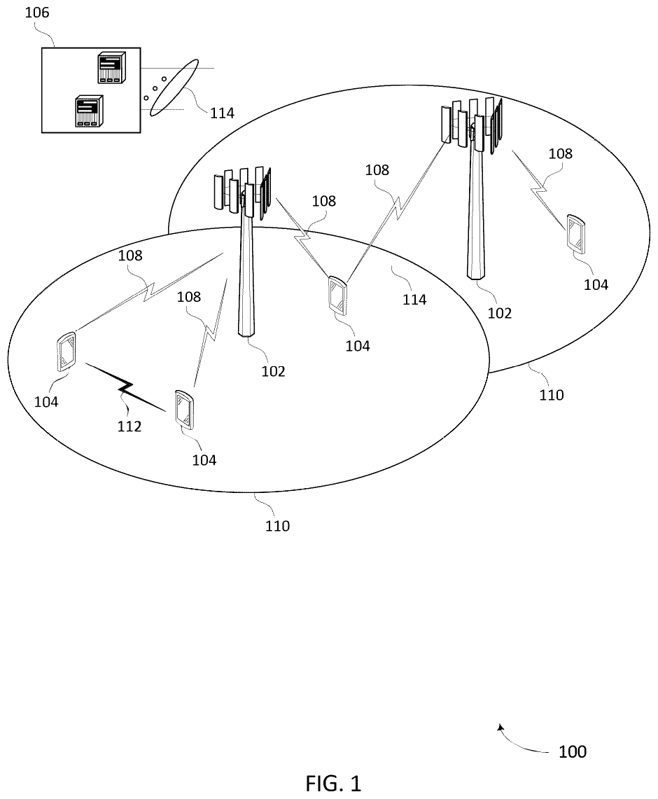

FIG. 1 illustrates an example of a wireless communications system 100 that supports a positioning reference signal for phase-based positioning in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (CNB), a next-generation NodeB (gNB), or other suitable terminology. A base station 102 and a UE 104 may communicate via a communication link 108, which may be a wireless or wired connection. For example, a base station 102 and a UE 104 may wireless communication over a Uu interface. In an embodiment, the communication link may carry a positioning reference signal.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communicate with each other over the backhaul links 114 (e.g., via an X2, Xn, or another network interface). In some implementations, the base stations 102 may communicate with each other directly (e.g., between the base stations 102). In some other implementations, the base stations 102 may communicate with each other or indirectly (e.g., via the core network 106). In some implementations, one or more base stations 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

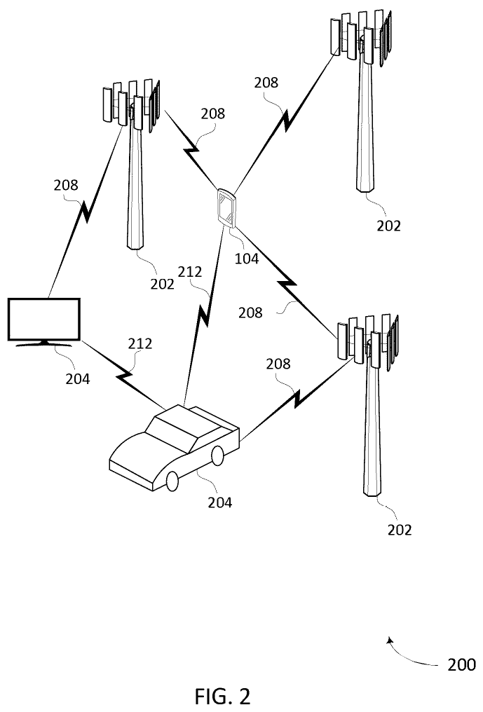

FIG. 2 illustrates an example of a positioning system 200 that supports a positioning reference signal for phase-based positioning in accordance with aspects of the present disclosure. System 200 shows three base stations 202 that are in communication with three UEs 204. The UEs may include stationary UEs such as a television, and mobile UEs such as a smartphone and a vehicle.

The UEs 204 communicate with base stations 202 through communication links 208, and between one another using side links 212. Each of the communication links 208 and side links 212 may include a positioning reference signal (PRS). Each of the base stations 202 and UEs 204 may be nodes that transmit and/or receive a PRS for absolute or relative positioning measurements.

A PRS in 5G may be transmitted by different base stations (serving and neighboring) using narrow beams, while in LTE, a PRS is transmitted across a whole cell. The PRS can be locally associated with a PRS Resource ID and Resource Set ID for a base station (TRP). Similarly, UE positioning measurements such as Reference Signal Time Difference (RSTD) and PRS RSRP (Reference Signal Received Power) measurements in a 5G system may be made between beams (e.g., between a different pair of DL PRS resources or DL PRS resource sets) as opposed to different cells as was the case in LTE.

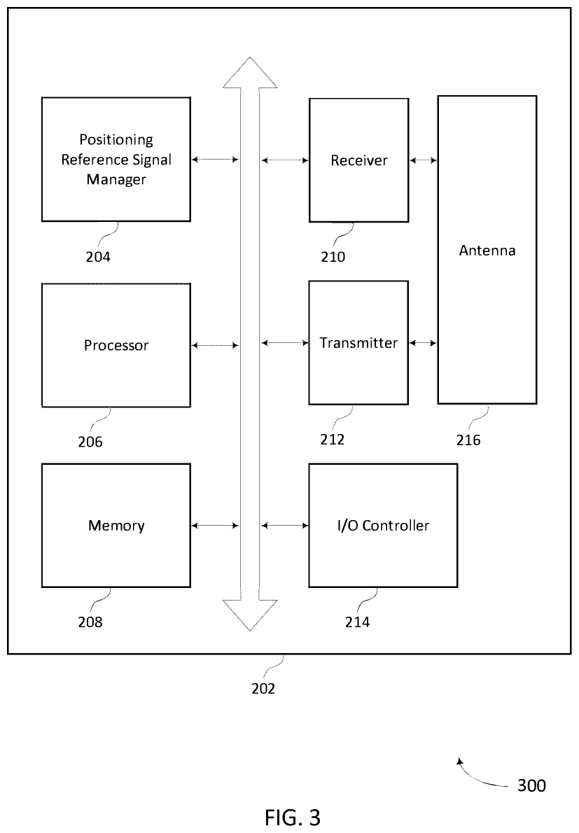

FIG. 3 illustrates an example of a block diagram 3 of a device 3 that supports carrier phase-based positioning reference signals in accordance with aspects of the present disclosure. The device 302 may be an example of [a base station 102 or a UE 104] as described herein. The device 302 may support wireless communication with one or more base stations 102, UEs 104, or any combination thereof. The device 302 may include components for bi-directional communications including components for transmitting and receiving communications, such as a PRS manager 304, a processor 306, a memory 308, a receiver 310, transmitter 312, and an I/O controller 314. These components may be in electronic communication or otherwise coupled (e.g., operatively, communicatively, functionally, electronically, electrically) via one or more interfaces (e.g., buses).

The PRS manager 304, the receiver 310, the transmitter 312, or various combinations thereof or various components thereof may be examples of means for performing various aspects of the present disclosure as described herein. For example, the PRS manager 304, the receiver 310, the transmitter 312, or various combinations or components thereof may support a method for performing one or more of the functions described herein.

In some implementations, the PRS manager 304, the receiver 310, the transmitter 312, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 306 and the memory 308 coupled with the processor 306 may be configured to perform one or more of the functions described herein (e.g., by executing, by the processor 306, instructions stored in the memory 308).

Additionally or alternatively, in some implementations, the PRS manager 304, the receiver 310, the transmitter 312, or various combinations or components thereof may be implemented in code (e.g., as communications management software or firmware) executed by the processor 306. If implemented in code executed by the processor 306, the functions of the PRS manager 304, the receiver 310, the transmitter 312, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the PRS manager 304 may be configured to perform various operations (e.g., receiving, monitoring, transmitting) using or otherwise in cooperation with the receiver 310, the transmitter 312, or both. For example, the PRS manager 304 may receive information from the receiver 310, send information to the transmitter 312, or be integrated in combination with the receiver 310, the transmitter 312, or both to receive information, transmit information, or perform various other operations as described herein. Although the PRS manager 304 is illustrated as a separate component, in some implementations, one or more functions described with reference to the PRS manager 304 may be supported by or performed by the processor 306, the memory 308, or any combination thereof. For example, the memory 308 may store code, which may include instructions executable by the processor 306 to cause the device 302 to perform various aspects of the present disclosure as described herein, or the processor 306 and the memory 308 may be otherwise configured to perform or support such operations.

For example, the PRS manager 304 may support wireless communication at a first device (e.g., the device 302) in accordance with examples as disclosed herein. The PRS manager 304 may be configured as or otherwise support phase-based positioning.

The processor 306 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 306 may be configured to operate a memory array using a memory controller. In some other implementations, a memory controller may be integrated into the processor 306. The processor 306 may be configured to execute computer-readable instructions stored in a memory (e.g., the memory 308) to cause the device 302 to perform various functions of the present disclosure.

The memory 308 may include random access memory (RAM) and read-only memory (ROM). The memory 308 may store computer-readable, computer-executable code including instructions that, when executed by the processor 306 cause the device 302 to perform various functions described herein. The code may be stored in a non-transitory computer-readable medium such as system memory or another type of memory. In some implementations, the code may not be directly executable by the processor 306 but may cause a computer (e.g., when compiled and executed) to perform functions described herein. In some implementations, the memory 308 may include, among other things, a basic I/O system (BIOS) which may control basic hardware or software operation such as the interaction with peripheral components or devices.

The I/O controller 314 may manage input and output signals for the device 302. The I/O controller 314 may also manage peripherals not integrated into the device 302. In some implementations, the I/O controller 314 may represent a physical connection or port to an external peripheral. In some implementations, the I/O controller 314 may utilize an operating system such as iOS®, ANDROID®, MS-DOS®, MS-WINDOWS®, OS/2®, UNIX®, LINUX®, or another known operating system. In some implementations, the I/O controller 314 may be implemented as part of a processor, such as the processor 306. In some implementations, a user may interact with the device 302 via the I/O controller 314 or via hardware components controlled by the I/O controller 314.

In some implementations, the device 302 may include a single antenna 316. However, in some other implementations, the device 302 may have more than one antenna 316, which may be capable of concurrently transmitting or receiving multiple wireless transmissions. The receiver 310 and the transmitter 312 may communicate bi-directionally, via the one or more antennas 316, wired, or wireless links as described herein. For example, the receiver 310 and the transmitter 312 may represent a wireless transceiver and may communicate bi-directionally with another wireless transceiver. The transceiver may also include a modem to modulate the packets, to provide the modulated packets to one or more antennas 316 for transmission, and to demodulate packets received from the one or more antennas 316.

This present disclosure details methods for enhancing the accuracy of the NR carrier phase measurements-based positioning. The disclosure mainly presents a new positioning reference signal (C-PRS) design, which will be transmitted to or from a target UE in order to perform accurate and reliable received phase tracking/measurements and determine the gNB-UE range/distance (including relative position) or the UE absolute position. The newly proposed reference signal can also be useful for phase noise tracking and compensation.

Embodiments of the present disclosure relate to a method to apparatus for configuring a continuous positioning reference signal (C-PRS) which is transmitted to or from a target UE to perform carrier phase measurements by estimating the phase of the received C-PRS. The phase measurements may be used to determine relative and/or absolute positions of the target UE. Embodiments extend to multiple processes in a wireless network, including generating, transmitting and receiving wireless signals, measuring and reporting phase, determining the location of a node, and mapping C-PRS to be contiguous in a resource block (RB). Various aspects of these processes may be performed by UEs 104, base stations 102, and a core network 106 as described with respect to FIG. 1. A C-PRS signal may be transmitted in an uplink, downlink or side link transmission to determine absolute or relative position of a UE.

Although the present disclosure describes the generated signal as being a positioning reference signal (PRS), embodiments are not limited to that specific signal. In other embodiments, the carrier phase reference signal design of the present disclosure may be extended to other reference signals used for positioning to estimate a target-UE's location, e.g., a Channel State Information Reference Signal (CSI-RS) or sounding reference signal (SRS). In various embodiments, aspects of the C-PRS may apply to other signals such as other reference signals, which may or may not be used primarily for positioning. A target-UE may refer to a device whose position is targeted by a positioning process.

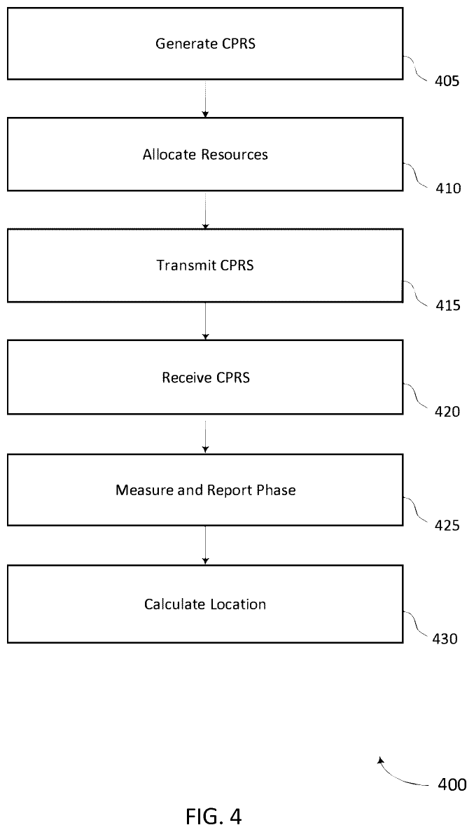

FIG. 4 illustrates a flowchart of a method 400 that supports continuous positioning reference signals (C-PRSs) in accordance with aspects of the present disclosure. The operations of method 400 may be implemented by a device or its components as described herein. For example, the operations of method 400 may be performed by a base station 102 or a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

At 405, the method may include generating a C-PRS. The operations of 405 may be performed in accordance with examples as described herein. In some implementations, aspects of the operations of 405 may be performed by a device as described with reference to FIG. 1.

FIG. 5 illustrates a flowchart of a method 500 that supports generating a C-PRS in accordance with aspects of the present disclosure. The operations of method 500 may be implemented by a device or its components as described herein. For example, the operations of method 500 may be performed by a base station 102 or a UE 104 as described with reference to FIGS. 1 and 2. In some implementations, the device may execute a set of instructions to control the function elements of the device to perform the described functions. Additionally, or alternatively, the device may perform aspects of the described functions using special-purpose hardware.

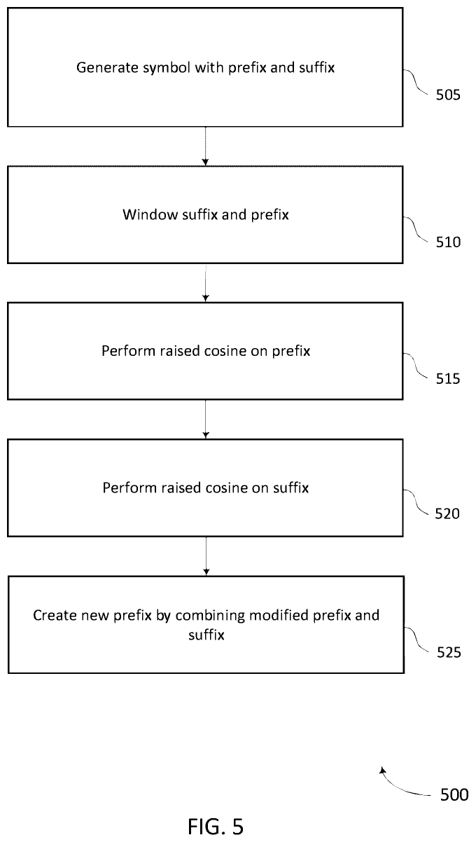

As illustrated in FIG. 6, a current cyclic prefix-orthogonal frequency division multiplexing (CP-OFDM) waveform presents discontinuities due to the presence of the cyclic prefix (CP). In other words, the tail portion of symbol samples N_CP from the Inverse Fast Fourier Transform (IFFT) output, that is copied and placed in the Cyclic Prefix region (beginning of the OFDM symbol), makes it difficult to create a continuous waveform.

Furthermore, the discontinuity in an unmodified CP-OFDM waveform makes it difficult or impossible to determine the phase of two such continuous symbols, even if they have a constant frequency, since the discontinuity may inhibit or prevent a device from being able to fix on and measure a phase. In particular, the discontinuity between adjacent symbols due to the CP introduces noise that makes it difficult to accurately measure the signal.

Embodiments may reduce or eliminate issues associated with a discontinuity between symbols using a raised cosine technique in the time domain. This technique allows for smoothing the edges of the OFDM symbol and having a continuous waveform without impacting the OFDM total symbol duration.

At 505, the method may include generating a symbol with a prefix and suffix. The operations of 505 may be performed in accordance with examples as described herein. In some implementations, aspects of the operations of 505 may be performed by a device as described with reference to FIG. 1.

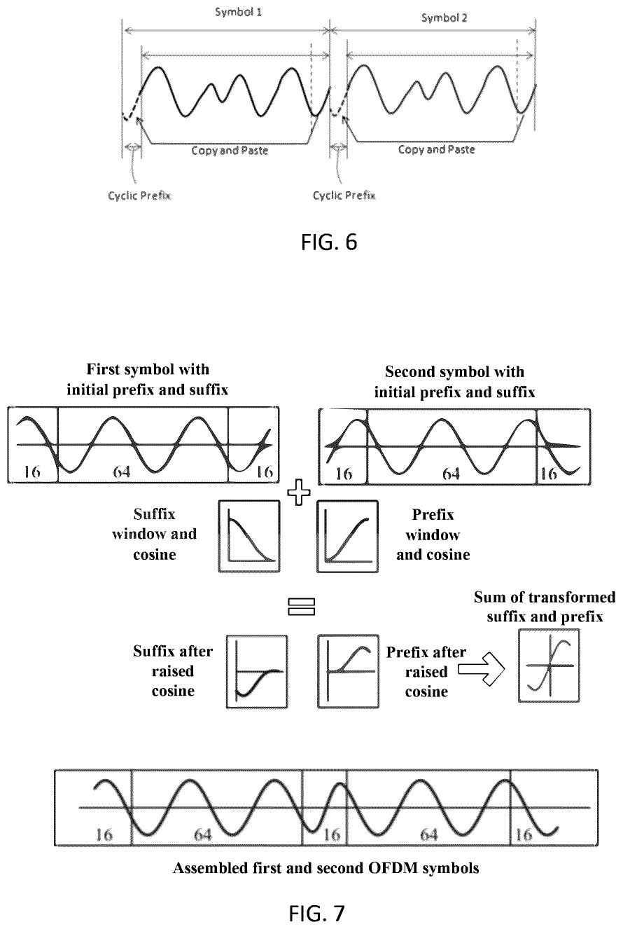

FIG. 7 shows an example of first and second symbols that are contiguous in the time domain. A cyclic suffix is introduced. Similar to cyclic prefix, a cyclic suffix may be defined as the first N_{CS}=16 samples out of N that are provided the end of a symbol, e.g. after a body of the symbol. In an embodiment, the suffix may be copied from a prefix. When a suffix has 16 samples and a prefix has 16 samples, a total symbol duration may be 96 samples (Nₜₒₜ=N+N_{CS}+N_{CP}=96). Arbitrarily lengthening a symbol will cause a cyclic suffix to overlap in time with a cyclic prefix of the next symbol. In an embodiment, the full sample generated at 505 may have a continuous sinusoidal waveform.

At 510, the method may include windowing a prefix and suffix. The operations of 510 may be performed in accordance with examples as described herein. In some implementations, aspects of the operations of 510 may be performed by a device as described with reference to FIG. 1.

To comply with the OFDM total symbol duration Nₜₒₜ=80, a windowing technique may be applied at 510 by windowing a cyclic prefix and cyclic suffix of contiguous C-PRS symbols.

In one aspect of the embodiment, both the suffix and prefix window length may be configured by a configuration entity such as a Location Management Function (LMF) or gNB, and devices performing windowing at 510 may do so according to that configuration. The window length may be characterized by a start and end time and/or window length, which may be based on a C-PRS symbol duration as a function of the configured Subcarrier Spacing (SCS).

At 515, the method may include performing a raised cosine on a prefix to create a transformed prefix. The operations of 515 may be performed in accordance with examples as described herein. In some implementations, aspects of the operations of 515 may be performed by a device as described with reference to FIG. 1.

As seen in FIG. 7, the cosine function used for the suffix window may be a rolled cosine that rolls on from 0 to 1. In an embodiment, the cosine function is multiplied by the original prefix. On a hardware level, a raised cosine filter may be applied to the prefix. When the raised cosine is applied to the prefix, the start or first sample of the prefix may retain its initial value (corresponding to the one), and the tail or final sample of the prefix may be zero.

In some embodiments, performing a raised cosine on a prefix at 515 may not be applied to the prefix of the first symbol in a plurality of contiguous C-PRS symbols in the time domain.

At 520, the method may include performing a raised cosine on a suffix to create a transformed suffix. The operations of 520 may be performed in accordance with examples as described herein. In some implementations, aspects of the operations of 520 may be performed by a device as described with reference to FIG. 1.

The raised cosine applied to the suffix may be the mathematical inverse of the raised cosine applied to the prefix. Specifically, the raised cosine applied to the suffix may roll off from 1 to 0. In an embodiment, the cosine function is multiplied by the original suffix. On a hardware level, a raised cosine filter may be applied to the suffix. When the raised cosine is applied to the suffix, the start or first sample of the prefix may be zero, and the tail or final sample of the prefix may retain its initial value (corresponding to the one).

At 525, the method may include creating a new prefix by combining the modified prefix and suffix from 515 and 520. The operations of 525 may be performed in accordance with examples as described herein. In some implementations, aspects of the operations of 525 may be performed by a device as described with reference to FIG. 1.

The prefix and suffix that were transformed at 515 and 520 are combined to create a new prefix at 525. In an embodiment, a transformed suffix and prefix may be overlapped and summed together to generate a 16-sample portion that is attached between adjacent C-PRS symbols in the time domain.

As shown in FIG. 7, a resulting C-PRS waveform, which includes the prefix that is the combined transformed prefix and suffix from 525, is substantially continuous. In particular, the end of an initial symbol is continuous with the beginning (or start of the prefix) of the next symbol in the time domain, while the total symbol duration is kept at 80 samples.

In some embodiments, performing a raised cosine on a suffix at 520 may not be applied to the suffix of the final symbol in a plurality of contiguous C-PRS symbols in the time domain.

At 410, the method may include allocating resources for one or more C-PRS. The operations of 410 may be performed in accordance with examples as described herein. In some implementations, aspects of the operations of 410 may be performed by a device as described with reference to FIG. 1.

Allocating resources for a C-PRS at 410 may include allocating frequency resources over which a C-PRS will be transmitted. In an embodiment, the bandwidth allocated to a C-PRS may be narrower than the bandwidth allocated to a conventional PRS. The C-PRS may start at any Physical Resource Block (PRB) in the system bandwidth and may be configured with a bandwidth ranging from 13 to 55 PRBs, for example. This amounts to a maximum bandwidth of about 20 MHz for 30 kHz subcarrier spacing and to about 80 MHz for 120 kHz subcarrier spacing.

The Crámer-Rao (CR) lower bound on the ranging error variances for both TDoA and carrier phase-based positioning are provided in Equations 1 and 2 below. The CR lower bound shows that the accuracy of timing-based positioning techniques depends on the reference signal bandwidth. However, carrier phase positioning accuracy does not depend on the bandwidth of the reference signal, and its positioning accuracy is instead related to the radio frequency.

$$var ( d ) \geq \frac{{c}^{2}}{\overline{{B}^{2}} * SNR} \qquad ( Equation 1 )$$

### In Equation 1,

$$\overline{{B}^{2}} = \frac{{\int }_{- ∞}^{∞} {( 2 π f )}^{2} {\vert S ( f ) \vert}^{2} df}{{\int }_{- ∞}^{∞} {\vert S ( f ) \vert}^{2} df}$$

is the mean square bandwidth of the signal and S(f) is the Fourier transform of the signal s(t).

$$var ( d ) \geq \frac{2 * {c}^{2}}{M * {( 2 π f )}^{2} * \frac{C}{{N}_{0}}} \qquad ( Equation 2 )$$

In Equation 2, var(d) is the ranging error variance, c is the speed of light, f is the radio frequency,

$$\frac{C}{{N}_{0}}$$

is the carrier-to-noise ratio, and M is the number of measurements.

In an embodiment, allocating resources at 410 may further include allocating blank resources such as Almost Blank Subframes (ABS) to the same time and frequency resources used to transmit a C-PRS. Blank resources may be applied to neighboring transmitters that could cause interference to a C-PRS at a target UE 104.

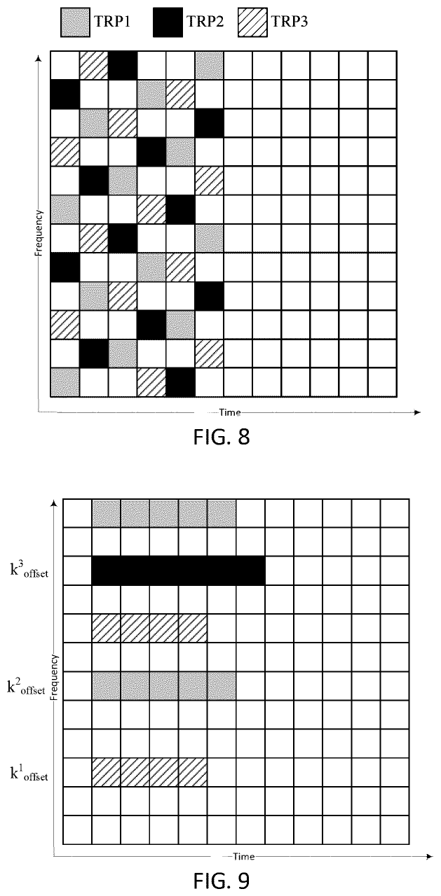

Conventional positioning reference signal design is based on a 31-bit Gold code sequence and a physical resource mapping according to a comb-structure in frequency. In this allocation, different BSs can be multiplexed on same slots using different frequency offsets. This design is very efficient and reliable for estimating the time of arrival (ToA) in presence of interfering DL PRSs from neighboring TRPs, when using a timing-based positioning technique. In this case, the higher the DL PRS bandwidth, the better the positioning accuracy. An example of resource allocation within a RB is shown in FIG. 8. Embodiments of the present disclosure may use a similar sequence generation technique for C-PRS in uplink and downlink frequencies.

For uplink carrier phase measurements, C-PRS allocations may be generated using conventional sequence generation. In this case, due to the relatively large number of users transmitting in the uplink, the pseudo random sequence can be initialized with a similar sequence with some modifications of some parameters such as the PRS sequence ID

$${n}_{ID , seq}^{PRS}$$

which may map a bigger interval than {0, 1, . . . , 4095}.

In an example, a reference-signal sequence r (m) is defined by

$$r ( m ) = \frac{1}{\sqrt{2}} ( 1 - 2 c ( 2 m ) ) + j \frac{1}{\sqrt{2}} ( 1 - 2 c ( 2 m + 1 ) ) \qquad ( Equation 3 )$$

The pseudo-random sequence generator may be initialized with:

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31} \qquad ( Equation 4 )$$

where

$${n}_{s , f}^{μ}$$

is the slot number, the PRS sequence ID

$${n}_{ID , seq}^{PRS} ∈ \{ 0 , 1 , … , 4095 \}$$

is given by the higher-layer parameter dl-PRS-Sequence-ID, and l is the OFDM symbol within the slot to which the sequence is mapped. Here, the PRS may be a C-PRS.

Furthermore, in an embodiment, a UE identifier UE_{ID} may be introduced in the initialization sequence in order to have more PRS sequences and to avoid pattern collisions. The UE_{ID} may be signaled by higher layers to each UE.

Reference signals for carrier phase measurements (e.g. C-PRS) may be mapped at a constant frequency into a block-type arrangement in the time domain. Accordingly, C-PRS transmissions are mapped to contiguous symbols in the time domain. Contiguous symbol mapping provides a constant subcarrier frequency during the phase estimation period, which provides a receiving node with sufficient time to lock onto a C-PRS and obtain an accurate measurement. The patterns used for C-PRS may be similar to patterns used for phase tracking reference signal (PTRS) design.

FIG. 9 illustrates an embodiment of C-PRS mapping to physical resources. Different UEs or TRPs may be multiplexed in the frequency domain on the same slots, each using a different subcarrier to avoid collision. In an embodiment, a non-contiguous mapping design as shown in FIG. 8 is used for uplink, while a contiguous mapping design as shown in FIG. 9 is used for downlink and/or side link. In the embodiment shown in FIG. 9, the allocated subcarriers are spaced apart by at least one subcarrier.

Different UEs or TRPs may be multiplexed in the time domain with different starting symbols and an appropriate number of symbols. In an embodiment, the number of symbols for C-PRS in time domain (given by L_{C-PRS}) can be configured. The length of a C-PRS in time domain could be configured by higher layers to be within the range, for example, of L_{C-PRS}∈{1, 2, 4, 6}. In some embodiments, the minimum number of contiguous slots for a C-PRS in the time domain is 2, 3, or 4 or 6 slots. different frequency offsets

$${k}_{C - PRS}^{offset}$$

may be configured for different UEs or TRPs to allow for C-PRS multiplexing on the same slot. In an embodiment, a repetition configuration may be used for added reliability.

C-PRS can be mapped to support one-shot positioning or continuous tracking. For continuous tracking, C-PRS can be mapped to slots in a repeating time interval.

At 415, the method may include transmitting the C-PRS. The operations of 415 may be performed in accordance with examples as described herein. In some implementations, aspects of the operations of 415 may be performed by a device as described with reference to FIG. 1.

A node that transmits a C-PRS may be a TRP or a UE. A UE 104 may transmit a C-PRS to a TRP, or more generally a base station 102, in uplink frequencies, and a base station 102 may transmit a C-PRS to UEs in downlink frequencies. A UE 104 may transmit a C-PRS to another UE in a side link frequency. The C-PRS may be transmitted on the resources allocated at 410.

At 420, the method may include receiving a C-PRS. The operations of 420 may be performed in accordance with examples as described herein. In some implementations, aspects of the operations of 420 may be performed by a device as described with reference to FIG. 1. A C-PRS may be received by a node in the network such as a UE 104 or base station 102.

At 425, the method may include measuring and reporting a phase of a received C-PRS. The operations of 425 may be performed in accordance with examples as described herein. In some implementations, aspects of the operations of 425 may be performed by a device as described with reference to FIG. 1.

Phase measurements may be performed on a received C-PRS, the phase measurements may be provided to a positioning measurement report, and the positioning measurement report may be transmitted to an entity that calculates location. For example, a UE 104 may measure the phase of a received C-PRS, provide the phase measurement to a positioning measurement report, transmit the positioning measurement report to a base station 102 which provides the report to a LMF in the core network.

At 430, the method may include calculating the location of a node. The operations of 430 may be performed in accordance with examples as described herein. In some implementations, aspects of the operations of 430 may be performed by a device as described with reference to FIG. 1.

The location of a target UE may be calculated at 430 by an appropriate node or network function. For example, the location may be calculated at 430 by a LMF in the core network. The location may be calculated using the phase measurements in a positioning measurement report received at 425. Any position measurement technique that uses distance can benefit from C-PRS measurements, including, for example, carrier phase-based positioning (CPP) in a NR network.

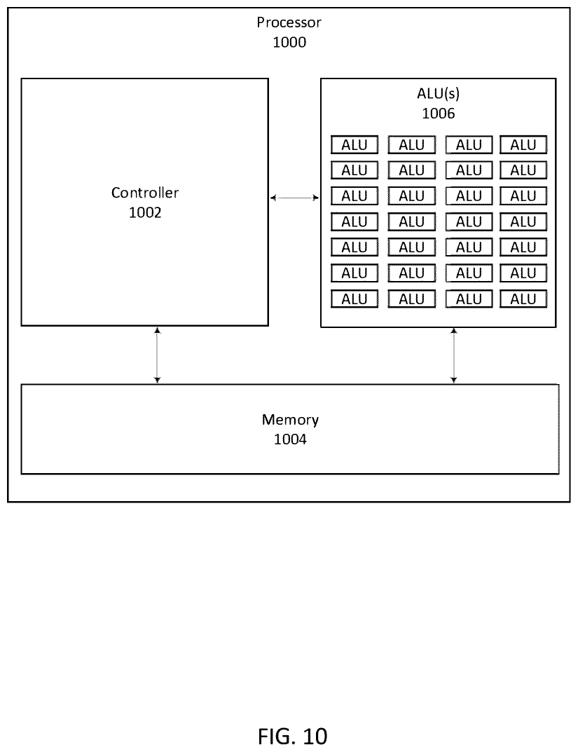

FIG. 10 illustrates an example of a processor 1000 that supports positioning reference signaling in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, such as L1/L2/L3 cache. Additionally, or alternatively, the processor 1000 may optionally include one or more arithmetic-logic units (ALUs) 1000. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementation, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, and the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1000 may be configured to support various operations in accordance with examples as described herein. In some implementations, the one or more ALUs 1000 may reside within or on a processor chipset (e.g., the processor 1000). In some other implementations, the one or more ALUs 1000 may reside external to the processor chipset (e.g., the processor 1000). One or more ALUs 1000 may perform one or more computations such as addition, subtraction, multiplication, and division on data. For example, one or more ALUs 1000 may receive input operands and an operation code, which determines an operation to be executed. One or more ALUs 1000 be configured with a variety of logical and arithmetic circuits, including adders, subtractors, shifters, and logic gates, to process and manipulate the data according to the operation. Additionally, or alternatively, the one or more ALUs 1000 may support logical operations such as AND, OR, exclusive-OR (XOR), not-OR (NOR), and not-AND (NAND), enabling the one or more ALUs 1000 to handle conditional operations, comparisons, and bitwise operations.

The processor 1000 may support wireless communication in accordance with examples as disclosed herein. The processor 1000 may be configured to or operable to support a means for positioning reference signaling.

It should be noted that the methods described herein describe possible implementations, and that the operations and the steps may be rearranged or otherwise modified and that other implementations are possible. Further, aspects from two or more of the methods may be combined.

An embodiment of an apparatus includes a transmitter configured to transmit a first continuous positioning reference signal, a receiver configured to receive a second continuous positioning reference signal from a network node, a processor, and a memory coupled with the processor, the processor configured to measure a phase of the second continuous positioning reference signal and provide the phase measurement in a positioning measurement report, wherein the first and second continuous positioning reference signal have a continuous cyclic prefix-orthogonal frequency division multiplexing (CP-OFDM) waveform across at least two contiguous symbols within a first subcarrier.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory;
a transceiver; and
at least one processor coupled with the at least one memory and configured to cause the UE to:
generate a continuous positioning reference signal for continuous tracking of phase for positioning using a raised cosine technique; and
transmit the continuous positioning reference signal, the continuous positioning reference signal extending across at least two contiguous symbols within a first subcarrier.

2. The UE of claim 1, wherein the at least one processor is further configured to cause the UE to:
generate the continuous positioning reference signal by combining a transformed suffix of a first symbol with a transformed prefix of a second symbol that is contiguous with the first symbol.

3. The UE of claim 2, wherein the at least one processor is further configured to cause the UE to:
generate the transformed suffix by applying a first raised cosine to an initial suffix of a first symbol; and
generate the transformed prefix by applying a second raised cosine to an initial prefix of a second symbol.

4. The UE of claim 3, wherein applying the first raised cosine to the initial suffix includes modifying the initial suffix by a cosine that starts at 1 and rolls off to 0.

5. The UE of claim 3, wherein applying the second raised cosine to the initial prefix includes modifying the initial prefix by a cosine that starts at 0 and rolls on to 1.

6. The UE of claim 2, wherein the first transformed suffix has 16 samples and the second transformed prefix has 16 samples.

7. The UE of claim 3, wherein a cosine of the first raised cosine applied to the initial suffix is an inverse of the second raised cosine applied to the initial prefix.

8. The UE of claim 2, wherein the combined suffix and prefix is used as a prefix for a symbol in the continuous positioning reference signal.

9. The UE of claim 1, wherein the at least one processor is further configured to cause the UE to receive a positioning measurement report including a phase measurement of the continuous positioning reference signal.

10. The UE of claim 9, wherein the at least one processor is further configured to cause the UE to provide the positioning measurement report including the phase measurement of the continuous positioning reference signal to a network function.

11. A processor for wireless communication, comprising:
at least one memory; and
a controller coupled with the at least one memory and configured to cause the controller to:
generate a continuous positioning reference signal for continuous tracking of phase for positioning using a raised cosine technique; and
transmit the continuous positioning reference signal, the continuous positioning reference signal extending across at least two contiguous symbols within a first subcarrier.

12. The processor of claim 11, wherein the controller is further configured to cause the controller to:
generate the continuous positioning reference signal by combining a transformed suffix of a first symbol with a transformed prefix of a second symbol that is contiguous with the first symbol.

13. The processor of claim 12, wherein the controller is further configured to cause the controller to:
generate the transformed suffix by applying a first raised cosine to an initial suffix of a first symbol; and
generate the transformed prefix by applying a second raised cosine to an initial prefix of a second symbol.

14. The processor of claim 13, wherein applying the first raised cosine to the initial suffix includes modifying the initial suffix by a cosine that starts at 1 and rolls off to 0.

15. The processor of claim 13, wherein applying the second raised cosine to the initial prefix includes modifying the initial prefix by a cosine that starts at 0 and rolls on to 1.

16. The processor of claim 12, wherein the first transformed suffix has 16 samples and the second transformed prefix has 16 samples, and
wherein the combined suffix and prefix is used as a prefix for a symbol in the continuous positioning reference signal.

17. The processor of claim 13, wherein a cosine of the first raised cosine applied to the initial suffix is an inverse of the second raised cosine applied to the initial prefix.

18. The processor of claim 11, wherein the controller is further configured to cause the controller to receive a positioning measurement report including a phase measurement of the continuous positioning reference signal, and
provide the positioning measurement report including the phase measurement of the continuous positioning reference signal to a network function.

19. A method performed by a user equipment (UE), the method comprising:
generating a continuous positioning reference signal for continuous tracking of phase for positioning using a raised cosine technique; and
transmitting the continuous positioning reference signal, the continuous positioning reference signal extending across at least two contiguous symbols within a first subcarrier.

20. A transmission reception point (TRP), comprising:
a processor; and
a transceiver coupled to the processor,
wherein the processor is configured to cause the TRP to:
generate a continuous positioning reference signal for continuous tracking of phase for positioning using a raised cosine technique; and
transmit the continuous positioning reference signal, the continuous positioning reference signal extending across at least two contiguous symbols within a first subcarrier.
